(19) United States
(12) Patent Application Publication
(10) Pub. No.: US 2008/0170316 A1
(43) Pub. Date: Jul. 17, 2008

(54) Method and apparatus for component level measurement of flying height for a head GIMBAL assembly for use in a hard disk drive

(75) Inventor: Dongman Kim, Campbell, CA (US)

Correspondence Address: GREGORY SMITH & ASSOCIATES, 3900 NEWPARK MALL ROAD, 3RD FLOOR, NEWARK, CA, 94560, US

(73) Assignee: SAMSUNG ELECTRONICS CO., LTD.

(21) Appl. No.: 11/654,738

(22) Filed: Jan. 17, 2007

(51) Int. Cl. G11B 27/36

(52) U.S. Cl. 360/31

(57) ABSTRACT

A method of using an optical test stand to perform both intensity-based and phase-based interferometry to create improved estimates of the flying height of a slider off of rotating disk surface, which are used to generate a three-dimensional map of the air bearing surface, crown and camber estimates, take-off and touch down estimates, all of which are product of these methods. Apparatus implementing these methods.

### TECHNICAL FIELD

This invention relates to the component level measurement of the flying height of a slider in a head gimbal assembly, in particular to the use of light based measurements to estimate the flying height capability of a head gimbal assembly before assembly in a hard disk drive.

### BACKGROUND OF THE INVENTION

The hard disk drive of today is rapidly evolving. The flying height of the slider above the disk surface has shrunk below ten nanometers, the threshold of nanotechnology. This progress has put significant strains on many aspects of the hard disk drive industry. Today, an optical technique is widely used to assess the flying height, or air gap, as it sometimes called. The previously prevailing intensity-based interferometry approaches have been found to have several weaknesses, even after compensating by using three distinct wavelengths, most of which are outside the blue to ultra-violet color spectrum, thus of longer wavelength.

Intensity-based interferometry is tending to be replaced by phase-based interferometry because it can provide higher sensitivity in such near-contact regimes. However, it is very expensive and requires extensive modification to both the measurement system hardware and the software used by such systems. What is needed is a method of accurately measuring parameters of a head gimbal assembly on a test stand without all of the expense of phase-based interferometry.

What is further needed is a test stand supporting measuring the effects of a slider flying over a surface comparable to a production disk surface in a fully assembled hard disk drive. Today this cannot be done except in a hard disk drive, which is a very expensive and restrictive environment for testing.

### SUMMARY OF THE INVENTION

One embodiment of the invention includes an optical test stand, comprising: A first optical interferometer using a first light source positioned by a light source actuator to originate a first light path and a second light path. The first light path includes a reflection off a first disk surface. And the second light path includes a reflection off the air bearing surface of a slider near a rotating disk surface opposite the first disk surface. The test disk is preferably transparent.

The light source actuator may preferably position the first light source with at least one degree of motion-freedom. The light source actuator may position the first light source with exactly one degree of motion-freedom. Alternatively, the light source actuator may position the first light source with two or more degrees of motion-freedom.

The motion of the first light source as positioned by the light source actuator may preferably be non-parallel to the motion of the air bearing surface of the slider as positioned by the actuator assembly. Further preferred, these motions may be approximately perpendicular.

The motion of the first light source as positioned by the light source actuator in conjunction with the motion of the air bearing surface of the slider as positioned by the actuator assembly may preferably support three dimensional contour mapping of the air bearing surface. The three dimensional contour mapping of the air bearing surface may preferably include an estimate of the crown and of the camber of the air bearing surface.

The optical test stand 200 may further include a second optical interferometer with a second light source to further refine the slider position.

The slider may include a vertical micro-actuator stimulated by a vertical actuation control signal. The three dimensional contour mapping of the air bearing surface may preferably include an estimate of a change in flying height of the read-write head of the slider when the vertical actuation control signal stimulates the vertical micro-actuator.

The optical test stand may further comprise a spin table include a first glass substrate coated with a protective layer topped by a layer of lubricant providing a rotating disk surface near which the air bearing surface of a slider is positioned by an actuator assembly. The first glass substrate is compatible with a second glass substrate used in a disk of a two and one half inch hard disk drive. The spin table is illuminated by a first optical interferometer measuring interference between a first light path and a second light path, both from a first light source. The first light path includes a reflection off a first disk surface opposite the rotating disk surface. And the second light path includes a reflection off the air bearing surface of the slider near the rotating disk surface.

The first glass substrate may provide the rotating disk surface with a first micro-waviness and the second glass substrate may provide a second rotating disk surface with a second micro-waviness, where the second rotating disk surface is included in the disk in the hard disk drive. In certain embodiments the first micro-waviness may preferably be essentially the same as the second micro-waviness. Alternatively, the first micro-waviness may preferably be within N percent of the second micro-waviness. Where N is at most twenty and N may further preferably be at most ten.

The optical test stand, may also comprise a first light source emitting at least one output band in the blue to ultra-violet color spectrum. The first light source originates a first light path and a second light path used by a first optical interferometer to measure the interference between the first light path and the second light path. The first light path includes a reflection off a first disk surface. And the second light path includes a reflection off the air bearing surface of a slider near a rotating disk surface opposite the first disk surface.

The output band may be composed of a monochromatic light output component or a polychromatic light component, both included in the blue to ultra-violet color spectrum. The first light source may preferably be a short wavelength coherent light source, preferably a laser, and even more preferably a laser diode. The first light source may provide at least two wavelengths. The first light source may further emit at least two output bands in the blue to ultra-violet color spectrum.

The emitted light of the first light source may preferably be in the blue to ultra-violet wavelength. As used herein, the blue to ultra-violet color spectrum may further include all electromagnetic radiation with a wavelength between 449 nanometers and 501 nanometers.

The first interferometer further operates and is methodically used as follows:
The light output of the first light source is presented to a splitter generating the first light path between the slider and a first disk surface, and a second light path of essentially the same distance as the first light path, varying slightly due to the path the light travels.
When these two light paths are combined, they form an interference pattern that is used in the interferometric detector. Both the first and second light paths end at this detector, which measures both the intensity and phase map of these two combined light paths and the reflections from the first light path are measured by an interferometric receiver and analyzed by a detector.
These measurements create an intensity curve and a phase curve. These two curves show distinct sensitivities, with the phase curve having improved sensitivity where the intensity curve has constant slope and vice versa.

A method may operate the optical test stand of the third embodiment to create a three-dimensional map of the air bearing surface of the slider, as follows:
Positioning the slider at a slider position through the head gimbal assembly.
Positioning the first light source at a first lighting position.
Generating a flying height estimate for the slider position and the first lighting position.
Adapting the flying height estimate for the slider position and the first lighting position to at least partly create the three-dimensional map of the air bearing surface.
Altering at least one of the first slider position and/or the first lighting position and repeating the above steps to further create the three-dimensional map of the air bearing surface.

A processor may preferably control the optical test stand to at least partly implement this method. The processor directs the positioning of the slider at a slider position through the head gimbal assembly. The processor directs the positioning of the first light source at a first lighting position through the light source actuator. The processor generates a flying height estimate for the slider position and the first lighting position. The processor adapts the flying height estimate for the slider position and the first lighting position to at least partly create the three-dimensional map of the air bearing surface. The processor alters at least one of the first slider position and/or the first lighting position and repeating the above steps to further create the three-dimensional map of the air bearing surface.

The first method may further include at least one of the following:
Deriving a camber estimate and a crown estimate for the air bearing surface.
Controlling a vertical micro-actuator included in the slider to create an estimate of a vertical actuated deformation of the slider while the vertical micro-actuator is stimulated.

The optical test stand may further be used to create a take-off estimate and/or a touch-down estimate based upon second altering the rotational rate for the means for controlling the rotation of the test disk and using the first method of creating the three-dimensional map. A take-off estimate is an estimate of the rotational rate at which the air bearing forms for the slider and the slider takes off from the rotating disk surface. Similarly, the touch-down estimate is an estimate of the rotational rate at which the air bearing collapses and the slider touches down to the rotating disk surface. The three dimensional map is preferred because where the slider makes contact with the rotating disk surface first and/or last is not uniform.

Certain further embodiments of the test stand which include climatic controls can be used to test lift degradation due to humidity, temperature and air pressure.

Embodiments may generate the flying height estimate of the slider from the rotating disk surface, by including the following:
Controlling the rotation of test disk to create a rotating disk surface at a rotational frequency.
Controlling a flying height a slider above the rotating disk surface, where the slider is coupled to and controlled through a head gimbal assembly.
Powering a light source to provide a light beam of at least one wavelength to the test disk to create a first optical response and to the slider to create a second optical response.
Measuring the first optical response to create a first optical reading at a first reading time.
Optically combining the first optical response and the second optical response to create an interference response.
Measuring the interference response to create a second optical reading at a second reading time.
Storing the first optical reading in a first reading table based upon the first reading time.
Storing the second optical reading in an interference table based upon the second reading time.
Deriving an intensity estimate based upon the first reading table, the second reading table and the rotational frequency.
Deriving a phase estimate based upon the first reading table, the second reading table, and the rotational frequency.
And estimating based upon the intensity estimate and the phase estimate to create an estimate of the flying height. The flying height estimate is a product of the invention's method.

The processor may preferably include at least one instance of a controller. As used herein, each controller receives at least one input, maintains and updates at least one state and generates at least one output based upon at least one of the inputs and/or at least one of the states.

As used herein, a controller may include an instance of a finite state machine, and/or include an instance of an inference engine and/or an instance of a neural network and/or an instance of a computer directed by a program system including program steps or operations residing in a memory accessibly coupled to the computer. As used herein, a computer includes at least one instruction processor and at least one data processor, where each of the data processors is directed by at least one of the instruction processors.

### BRIEF DESCRIPTION OF THE DRAWINGS

FIG. 1A shows a third embodiment of the optical test stand including a light source actuator for position the first light source;

FIGS. 1B to 1D show various examples of the motion of the light source of FIG. 1A;

FIG. 1E shows an example of a three-dimensional map of the air bearing surface created using the third embodiment of the optical test stand;

FIGS. 1F and 1G show the crown of the slider;

FIG. 1H shows the camber of the slider;

FIGS. 1J and 1K show an example of a vertical actuated deformation of the slider and the flying height change resulting from activating a vertical micro-actuator included in the slider;

FIG. 2A shows a second embodiment of an optical test stand where the light beam includes at least one output band in the blue to ultra-violet color spectrum as shown through the examples of FIGS. 2B to 2E;

FIG. 3A shows an example of the first embodiment of the optical test stand of FIG. 2A using the first glass substrate in the test disk, where the first glass substrate is compatible with a second glass substrate used in a disk in a hard disk drive, preferably a 2.5 inch hard disk drive;

FIG. 3B shows a detail of FIG. 3A further showing the first micro-waviness of the first glass substrate which is compatible with the second micro-waviness of the second glass substrate;

FIGS. 4A and 4B show elements of the optical test stand in terms of an interferometric receiver and an interferometric detector communicating via an interferometric communicative coupling;

FIG. 5A shows an example of an intensity curve used with various embodiments and methods;

FIG. 5B shows an example of a phase curve used with various embodiments and methods;

FIGS. 6A to 7 show a control system including a processor operating the optical test stand to implement a method of using the optical test stand to create a three-dimensional map of the air bearing surface of the slider being tested;

FIG. 8A shows the processor including at least one instance of a controller implementing the method of using the optical test stand to create the three-dimensional map;

FIG. 8B shows an example of the controller receiving at least one input, maintaining and updating the value of at least one state and generating at least one output based upon at least one of the inputs and/or the value of at least one of the states;

FIGS. 8C and 8D show some details of the values of a state of a controller;

FIG. 8E shows an instance of a controller including a finite state machine;

FIG. 8F shows an instance of a controller including an inference engine;

FIG. 8G shows an instance of a controller including a neural network;

FIG. 9A shows the processor of FIGS. 6, 7 and 8A including an instance of the controller, including a computer accessibly coupled via a buss to a memory and at least partly directed by a program system to support the method creating the three-dimensional map of the air bearing surface of the slider being tested in the optical test stand;

FIG. 9B shows one member of the means group of FIG. 7 including a finite state machine;

FIG. 9C shows one member of the means group of FIG. 7 including an inference engine;

FIG. 9D shows one member of the means group of FIG. 7 including a neural network;

FIG. 9E shows one member of the means group of FIG. 7 including a computer;

FIGS. 10 to 13 show some details of the method creating the three-dimensional map of the air bearing surface;

FIGS. 14 and 15 show using the method of generating the three-dimensional map using the optical test stand to create a take-off estimate and/or a touch down-estimate.

### DETAILED DESCRIPTION

This invention relates to the component level measurement of the flying height of a slider in a head gimbal assembly, in particular to the use of light based measurements to estimate the flying height capability of a head gimbal assembly before assembly in a hard disk drive.

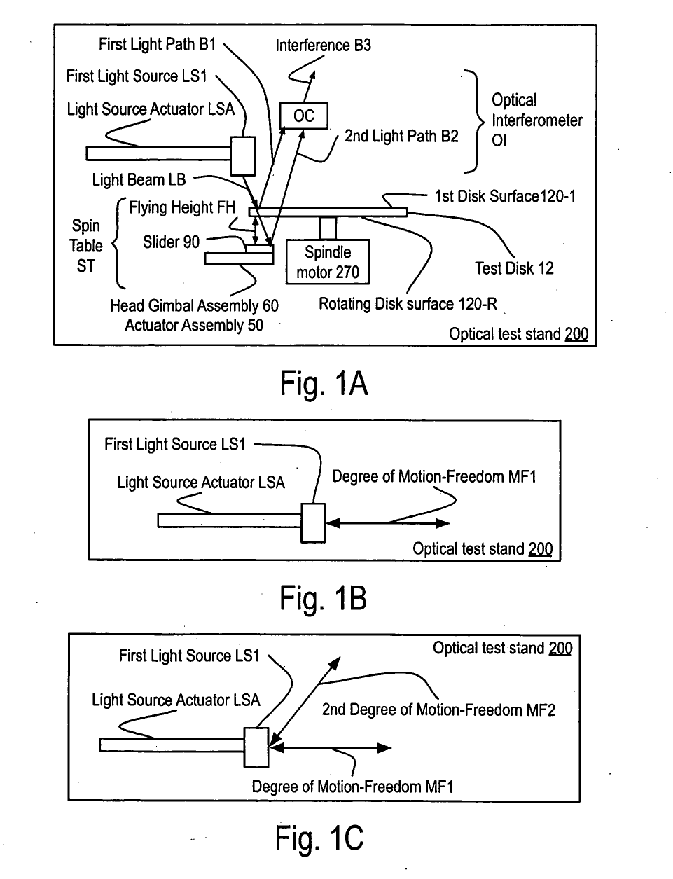

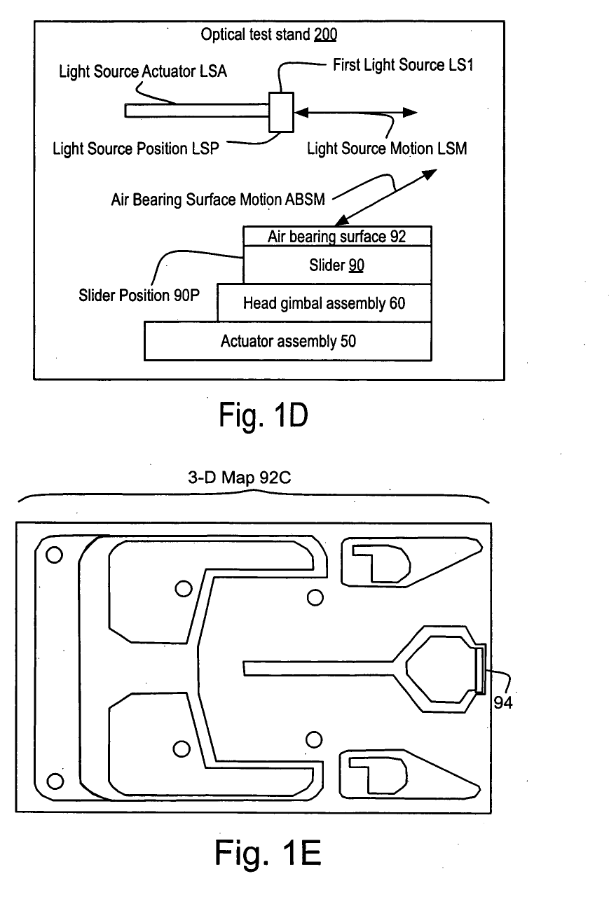

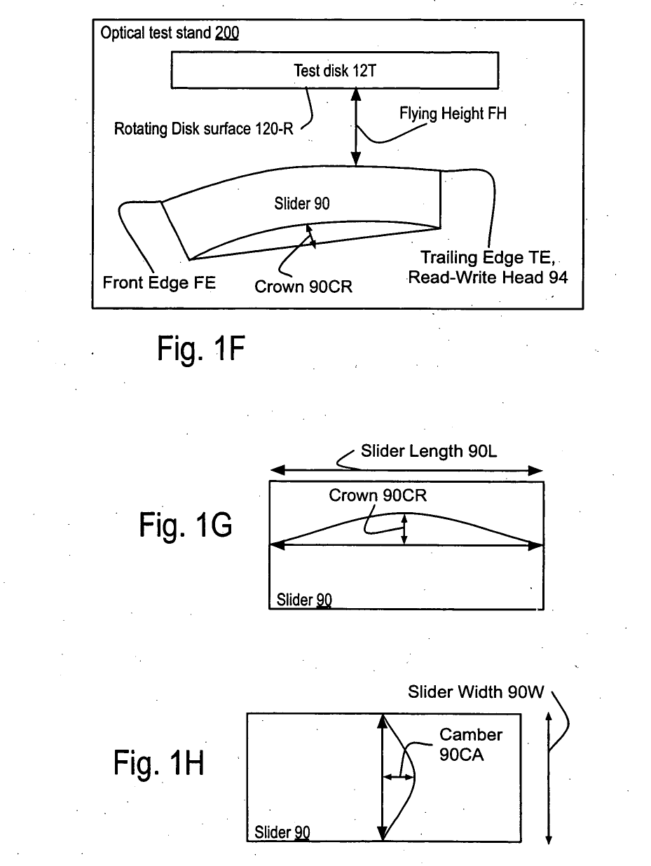

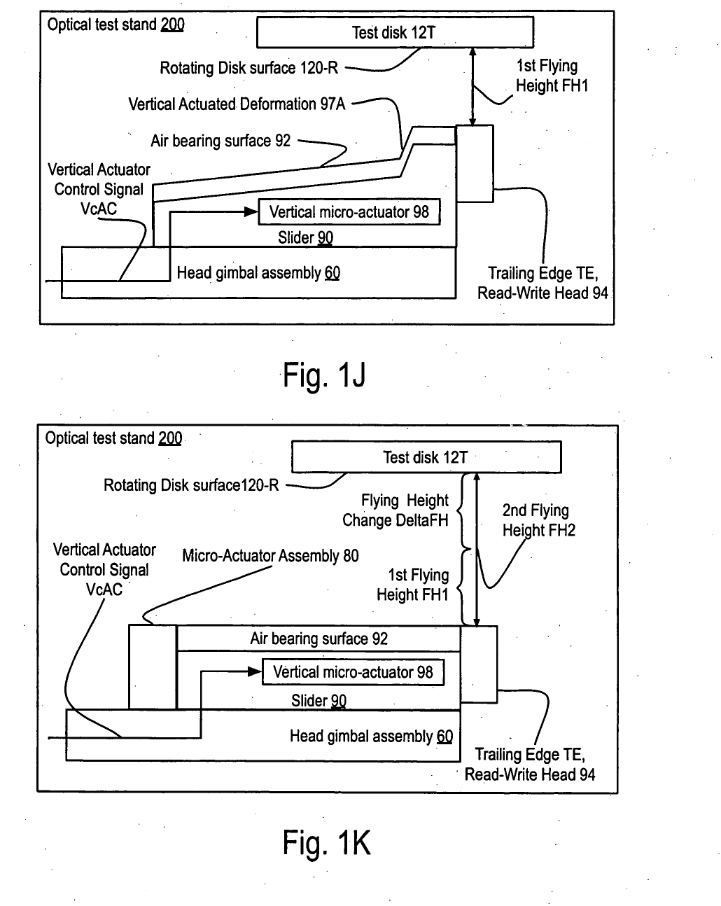

An embodiment may preferably include the optical test stand 200 as shown in FIGS. 1A to 1K, comprising: The optical interferometer OI uses a first light source LS1 positioned by a light source actuator LSA to originate the first light path B1 and the second light path B2. The first light path includes the reflection off the test disk surface 120-1. And the second light path includes the reflection off the air bearing surface 92 of the slider 90 near a rotating disk surface 120-R opposite the test disk surface.

The light source actuator LSA may preferably position the first light source LS1 with at least one degree of motion-freedom. The light source actuator may position the first light source with exactly one degree of motion-freedom MF1, as shown in FIG. 1B. Alternatively, the light source actuator may position the first light source with two or more degrees of motion-freedom as shown in FIG. 1C with a second degree of motion-freedom MF2.

The motion of the first light source LS1 as, positioned by the light source actuator LSA may preferably be non-parallel to the motion of the air bearing surface 92, referred to herein as the air bearing surface motion ABSM, of the slider 90 as positioned by the actuator assembly 50 and the head gimbal assembly 60, as shown in FIG. 1D. Further preferred, these motions may be approximately perpendicular.

The motion of the first light source LS1, referred to herein as the light source motion LSM, is positioned by the light source actuator LSA in conjunction with the motion of the air bearing surface, referred to herein as the air bearing surface motion ABSM, of the slider 90 as positioned by the actuator assembly 50 may preferably support three dimensional contour mapping of the air bearing surface 92, which creates a 3-D contour 92C as shown in FIG. 1E.

The three dimensional contour mapping of the air bearing surface 92 may preferably provide an estimate of the crown 90CR as shown in FIGS. 1F and 1G and an estimate of the camber 90CA as shown in FIG. 1H, both of which are often associated with the slider 90. Put another way, the crown 90CR refers herein to a measure of the bending of the slider 90 along the slider length 90L, and the camber 90CA refers to a measure of the bending of the slider along the slider width 90W.

Measurements may also be made of the twist of the slider, which is usually denoted as the bending of the slider between its opposite corners.

By way of example, the optical test stand 200 may be used with a pico slider 90, which is often considered to have a slider length of 1.235 millimeters (mm) and a slider width of 1.00 mm. Another example, the optical test stand may be used with a pemto slider, which is often considered to have a slider length of 1.235 millimeters (mm) and a slider width of 0.70 mm. Another example, the optical test stand may be used with a femto slider, often considered to have a slider length of 0.85 mm and a slider width of 0.70 mm.

The optical test stand 200 may further include a second optical interferometer with a second light source to further refine the slider position.

In certain embodiments, the slider 90 may include a vertical micro-actuator 98 stimulated by a vertical actuator control signal VcAC. The three dimensional contour mapping of the air bearing surface may preferably include an estimate of a change in flying height FH, which will be referred to as the flying height change DeltaFH of the read-write head 94 of the slider 90 when the vertical actuation control signal stimulates the vertical micro-actuator as shown in FIGS. 1J and 1K.

These Figures shown an example of the slider including a vertical micro-actuator using a thermal-mechanical effect, where the effect of stimulating the vertical actuator control signal VcAC causes the vertical micro-actuator 98 to heat a region of the slider as shown in FIG. 1J, thereby causing the first flying height FH1 to be closer to the rotating disk surface 120-R of the test disk 12T, than the second flying height FH2, as shown in FIG. 1K.

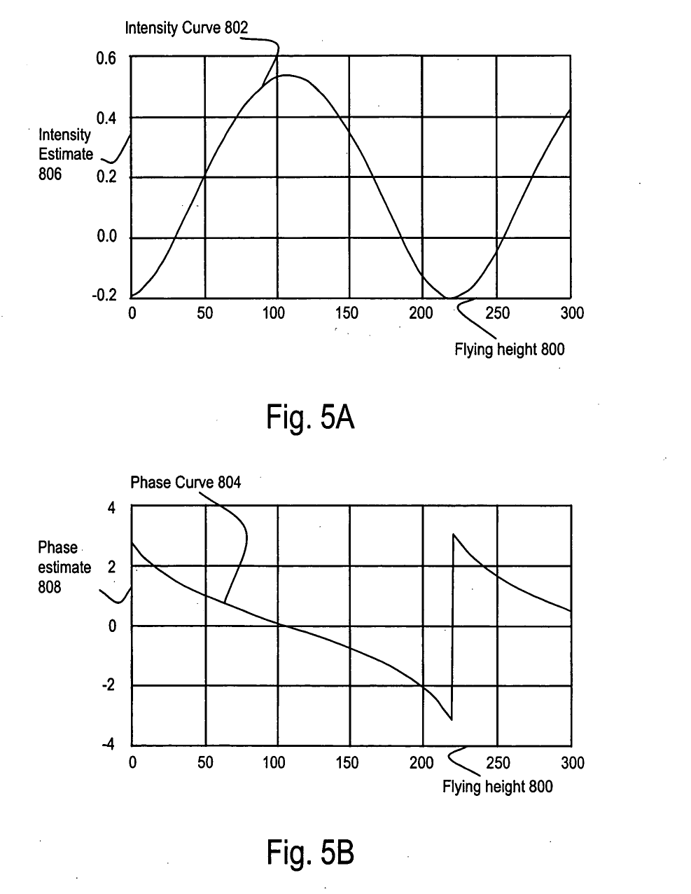

In this example, the flying height change DeltaFH is the difference between two flying heights, in this example, between the second flying height FH2 and the first flying height FH1. Alternatively the flying height change DeltaFH may be difference between the first flying height FH1 and the second flying height FH2. Other embodiments of the vertical micro-actuator 98 may use a piezoelectric effect and/or an electrostatic effect to alter the flying height FH, but in general, they will operate very similarly to the example shown in FIGS. 1J and 1K, the primary point of variation may be whether FIG. 5A represents the stimulated or the unstimulated result of the vertical micro-actuator.

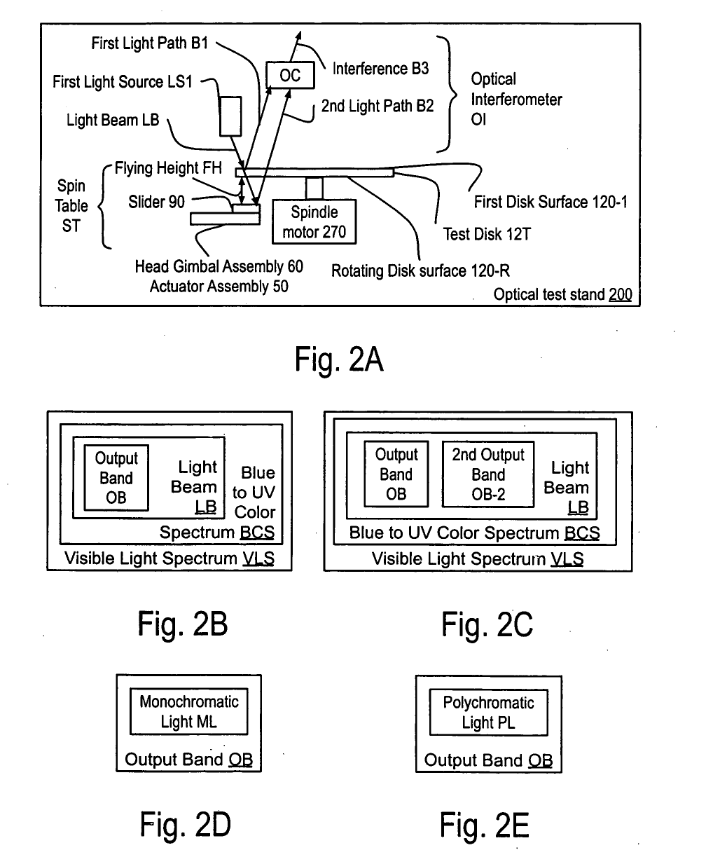

The optical test stand 200 as shown in FIG. 2A, may further comprise: The first light source LS1 emitting at least one output band OB in the blue to ultra-violet color spectrum BCS, as shown in FIGS. 2B. The first light source originates the first light path B1 and the second light path B2 used by the optical interferometer OI to measure the interference B3 between the first light path and the second light path. The first light path includes a reflection off a test disk surface 120-1. And the second light path includes a reflection off the air bearing surface 92 of the slider 90 near the rotating disk surface 120-R opposite the test disk surface.

The output band OB may be composed of a monochromatic light component ML or a polychromatic light component PL, both included in the blue to ultra-violet color spectrum BCS, as shown in FIGS. 2D and 2E. The first light source LS1 may preferably be a short wavelength coherent light source, preferably a laser, and even more preferably a laser diode.

The first light source may provide at least two wavelengths, in certain embodiments as two output bands as shown in FIG. 2C, each including monochromatic light, and in other embodiments as a single output band including polychromatic light. The first light source may further emit the at least two output bands in the blue to ultra-violet color spectrum.

The emitted light of the first light source LS1 may preferably be in the blue to ultra-violet wavelength, which will be referred to herein as the blue to ultra-violet color spectrum BCS.

As used herein, the blue to ultra-violet color spectrum may further include all electromagnetic radiation with a wavelength between 449 nanometers and 501 nanometers. As used herein, the blue to ultra-violet color spectrum is considered a subset of the visible light spectrum VLS.

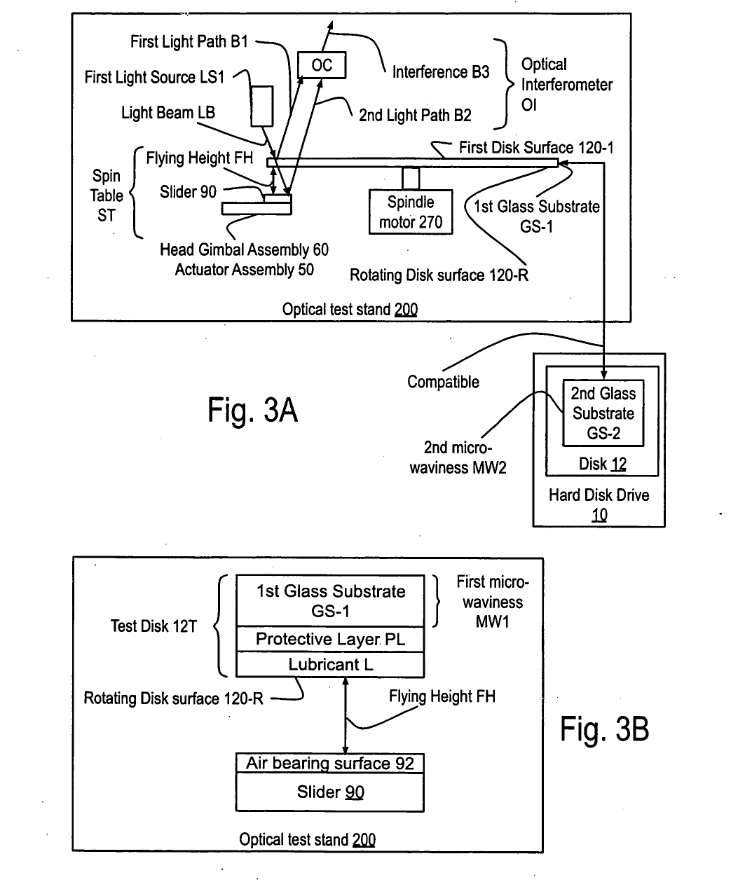

The optical test stand 200 as shown in FIGS. 3A and 3B, may further comprise the following:
A spin table ST may preferably include a first glass substrate GS-1 coated with a protective layer PL topped by a layer of lubricant L providing a rotating disk surface 120 near which the air bearing surface 92 of a slider is positioned by an actuator assembly 50, which preferably couples to the slider through a head gimbal assembly 60.
The first glass substrate is compatible 8 with a second glass substrate GS-2 used in a disk 12 of a two and one half inch hard disk drive 10.
The spin table ST is illuminated by a optical interferometer OI measuring an interference B3 between a first light path B1 and a second light path B2, both from a first light source LS1.
The first light path B13 includes a reflection off a test disk surface 120-1 opposite the rotating disk surface 120-R.
And the second light path B2 includes a reflection off the air bearing surface 92 of the slider 90 near the rotating disk surface 120-R.

The test disk 12T may be manufactured by providing the compatible first glass substrate GS-1. The protective layer PL is deposited on the first glass substrate by sputtering carbon for form a protective, diamond like carbon layer, which is the same protective layer created on the disk 12 in the hard disk drive 10. The test disk is then lubricated with, preferably, same lubricant L as is used for the disk in the hard disk drive.

The first glass substrate GS-1 may provide the rotating disk surface 120-R with a first micro-waviness MW1 and the second glass substrate GS-2 may provide a second rotating disk surface of the disk 12 with a second micro-waviness MW2, where the second rotating disk surface is included in the disk in the hard disk drive 10, preferably a 2.5 inch hard disk drive. The first micro-waviness may be essentially the same as the second micro-waviness. Alternatively, the first micro-waviness MW1 may preferably be within N percent of the second micro-waviness MW2. Where N is at most twenty and N may further preferably be at most ten.

As used herein micro-waviness MW and waviness are often measured in terms of the angstroms at several output band OB. In the following table, micro-meters will be represented by μm, nanometers by nm, and angstroms by A. The table summarizes some of these compatible measurements:

TABLE ONE
showing a test disk 12T with a first glass substrate GS-1 compatible 8 with
two examples of a hard disk drive 10.

| | | Test disk 12-T | | First hard disk drive | | Second hard disk | |
|---|---|---|---|---|---|---|---|
| | | | Rotating | 10 | | drive 10 | |
| | | First disk | disk | Disk 12 | 2^{nd} disk | Disk 12 | 2^{nd} disk |
| | Wavelength | surface | surface | first disk | first disk | first disk | first disk |
| Parameter | Range | 120-1 | 120-R | surface | surface | surface | surface |
| Micro- | 200–1500 μm | 2.79 A | 2.52 A | 3.66 A | 3.60 A | 3.23 A | 2.64 A |
| waviness | | | | | | | |
| waviness | 400–5000 μm | 0.602 nm | 0.586 nm | 0.391 nm | 0.385 nm | 0.468 nm | 0.460 nm |

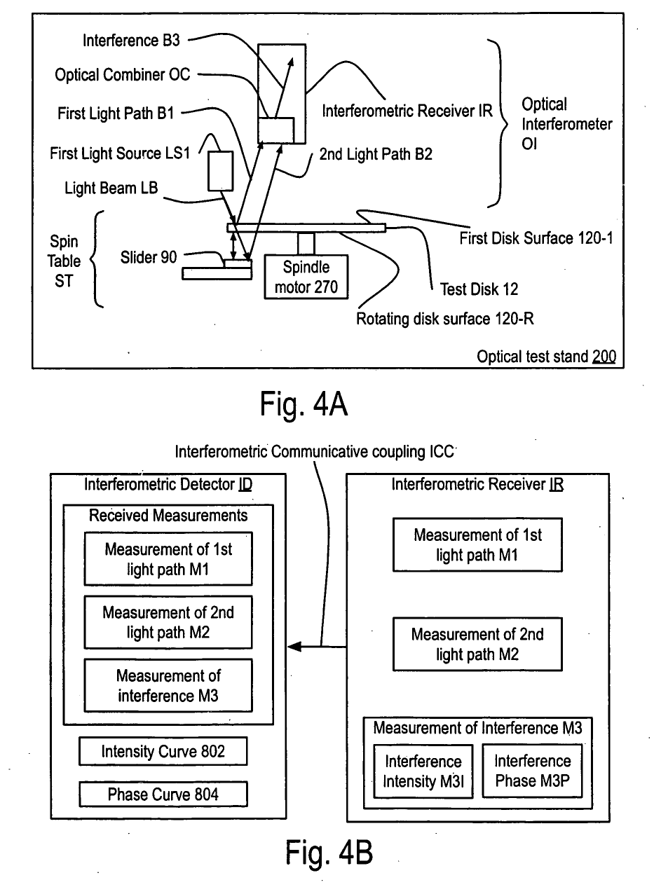

The first optical interferometer OI as shown in FIGS. 4A and 4B further operates and is methodically used as follows:
The light output of the first light source LS1 is presented to a splitter generating the first light path B1 between the slider 90 and the test disk surface 120-1, and the second light path B2 of essentially the same distance as the first light path.
Both the first light path B1 and the second light path B2 may preferably end at an interferometric receiver IR, which may preferably measures both the intensity and phase of these two light paths as shown in FIG. 4A. These measurements are sent by the interferometric receiver to be analyzed by an interferometric detector ID as shown in FIG. 4B.

These measurements are used by the interferometric detector to create an intensity curve 802 shown in some detail in FIG. 5A and a phase curve 804 shown in some detail in FIG. 5B. These two curves show distinct sensitivities, with the phase curve having improved sensitivity where the intensity curve has constant slope and vice versa. The horizontal axis 800 of both Figures represents the flying height FH of the slider 90 over the rotating disk surface 120-R in units of nanometers. The vertical axis 808 of FIG. 5B preferably represents radian units of a phase estimate 158. The vertical axis 806 of FIG. 5A represents an intensity estimate 156, which will shortly be described in greater detail.

One way to understand the relationship between flying height FH and the intensity estimate 154 is to consider the following theoretical example, which is based upon the thin film equation. Assuming the following notation:
h represents the flying height FH of the slider.
λ represents the wavelength of the light beam LB,
n₀ represents the refractive index of air.
(n, +ik₁)represents the refractive index of the slider 90.
(n₂+ik₂)represents the refractive index of the first glass substrate GS-1.
r₂₀ represents the reflection coefficient of the glass-air boundary.
r₀₁ represents the reflection coefficient of the air-slider boundary.
I₀ represents intensity of the light incident to the slider-disk interface, which is also known herein as the first light path B1.
I_{S} represents intensity of the light reflected from the slider-disk interface, which is also known herein as the second light path B2.

The reflected intensity I_{S} is related to the previous items by the following formulas:

$$\begin{matrix}{I}_{S} = {I}_{0} \frac{{r}_{20}^{2} + {\vert {r}_{01} \vert}^{2} + 2 {r}_{20} \vert {r}_{01} \vert cos ( δ + {φ}_{S} )}{1 + {r}_{20}^{2} {\vert {r}_{01} \vert}^{2} + 2 {r}_{20} \vert {r}_{01} \vert cos ( δ + {φ}_{S} )} & ( 0.1 ) \\ δ = 4 π h / λ & ( 0.2 ) \\ {φ}_{S} = π - {tan}^{- 1} ( \frac{2 {n}_{0} {k}_{1}}{{n}_{0}^{2} - {n}_{1}^{2} - {k}_{1}^{2}} ) & ( 0.3 ) \\ {r}_{20} = \frac{( {n}_{2} + {ik}_{2} ) - {n}_{0}}{( {n}_{2} + {ik}_{2} ) + {n}_{0}} . & ( 0.4 ) \\ {r}_{01} = \frac{{n}_{0} - ( {n}_{1} + {ik}_{1} )}{{n}_{0} + ( {n}_{1} + {ik}_{1} )} & ( 0.5 )\end{matrix}$$

These formulas illustrate the relationship shown in the intensity curve 802 of FIG. 5A.

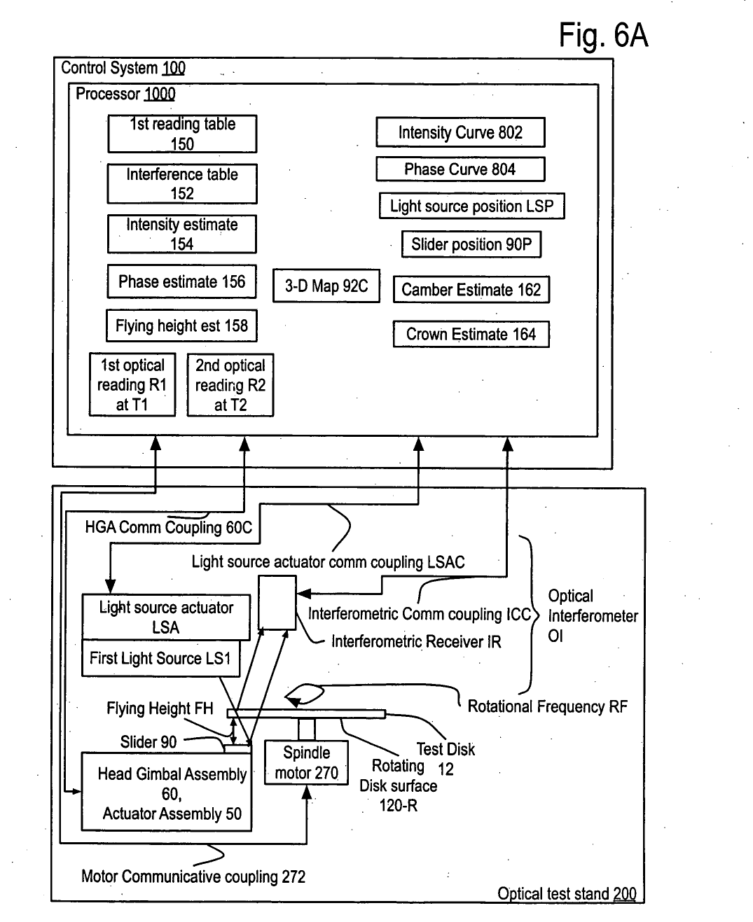

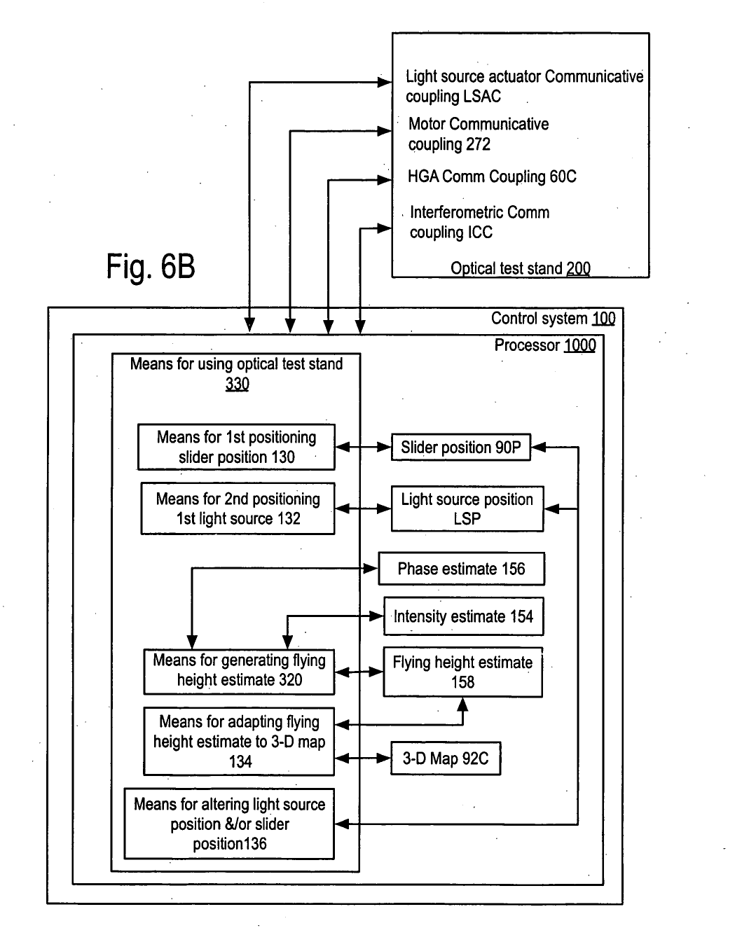

The interferometric detector ID may further operate within a control system 100 for an optical test stand as shown in FIG. 6.
A processor 1000 may embody the interferometer detector ID of FIG. 4B interacting through an interferometric communications coupling ICC with the interferometric receiver IR.
The processor may also preferably control the spindle motor 270 through a motor communicative coupling 272.
The processor may also preferably control the positioning of the slider 90 through a head gimbal assembly communicative coupling 60C to the actuator assembly 50 and further to the head gimbal assembly 60, which includes the slider.

Several Figures show flowcharts of various aspects and/or details of these methods and possess arrows. These arrows will signify of flow of control and sometimes data, supporting implementations including at least one program step or program thread executing upon a computer 300, inferential links in an inference engine IE, state transitions in a finite state machine FSM, and learned responses within a neural network NN.

The operation of starting a flowchart refers to at least one of the following and is denoted by an oval with the text “Start” in it:
Entering a subroutine in a macro instruction sequence in a computer 300.
Entering into a deeper node of an inferential graph of an inference engine IE.
Directing a state transition in a finite state machine FSM, possibly while pushing a return state.
And triggering at least one neuron in a neural network NN.

The operation of termination in a flowchart refers to at least one of the following and is denoted by an oval with the text “Exit” in it:
The completion of those steps, which may result in a subroutine return in a computer 300.
Traversal of a higher node in an inferential graph of an inference engine IE.
Popping of a previously stored state in a finite state machine FSM.
Return to dormancy of the firing neurons of the neural network NN.

An operation in a flowchart refers to at least one of the following:
The instruction processor responds to the step as a program step to control the data execution unit in at least partly implementing the step within a computer 300.
The inference engine IE responds to the step as nodes and transitions within an inferential graph based upon and modifying a inference database in at least partly implementing the step.
The neural network NN responds to the step as stimulus in at least partly implementing the step.
The finite state machine FSM responds to the step as at least one member of a finite state collection comprising a state and a state transition, implementing at least part of the step.

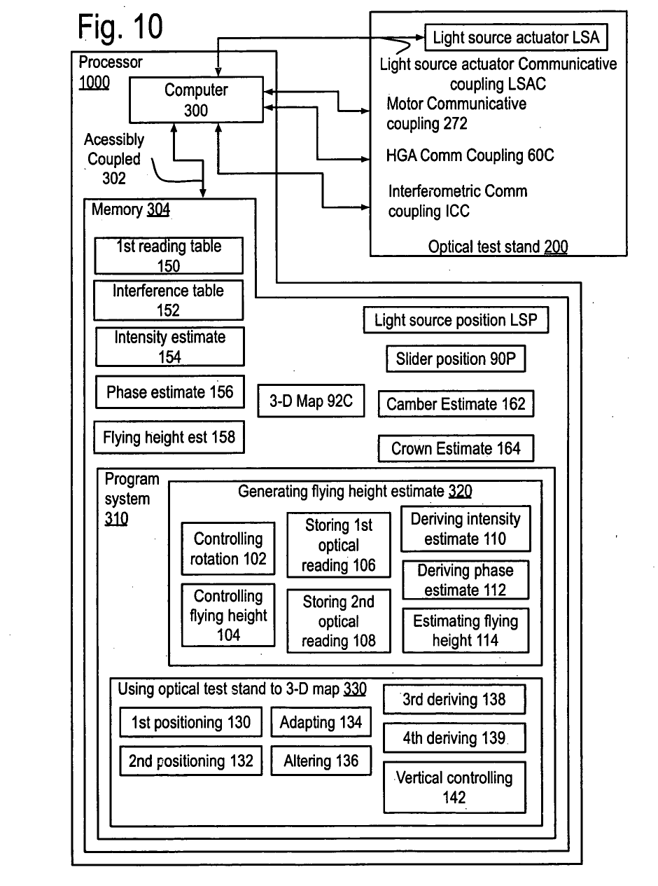

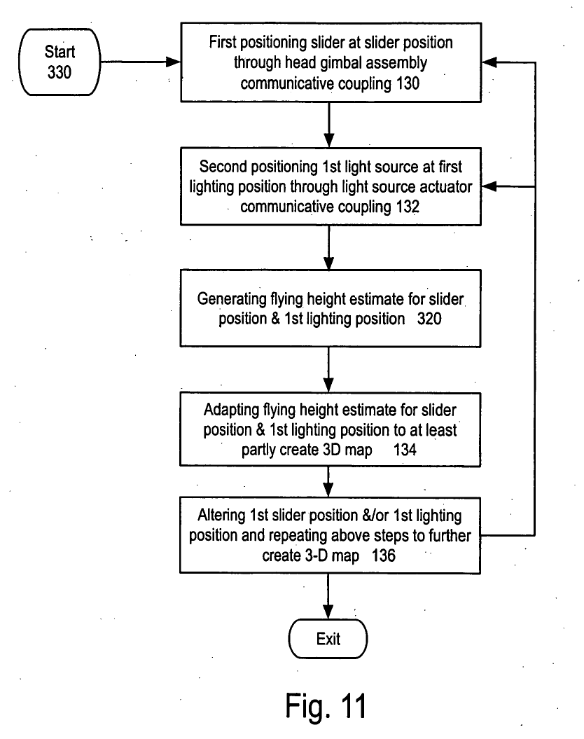

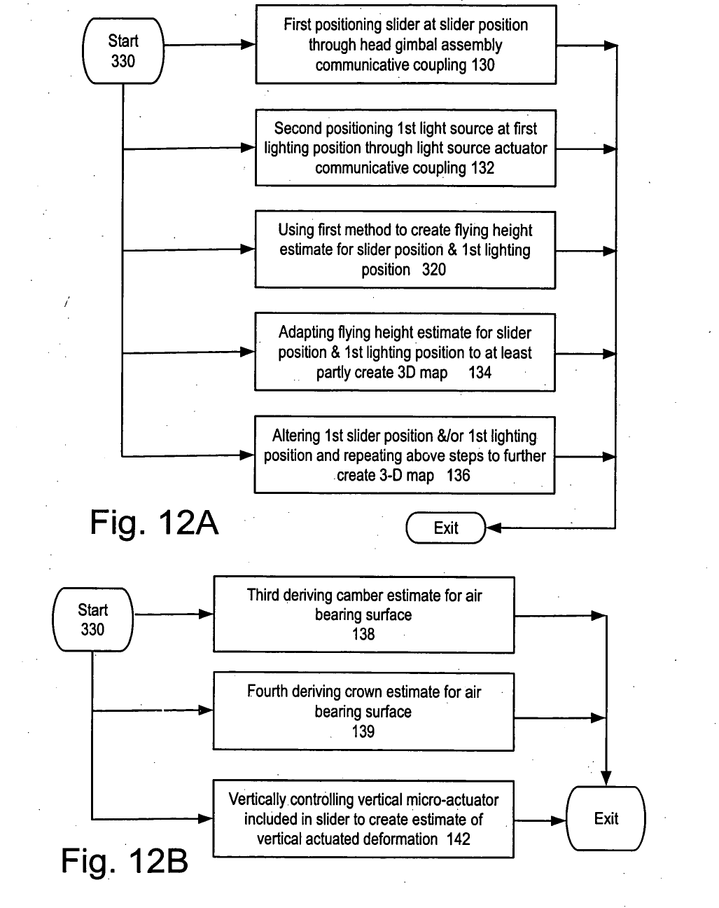

The program system 310 will be used to illustrate a first method 330 as shown in FIG. 10 preferably operating the optical test stand 200 as shown in FIG. 1A, controlling the light source actuator LSA via the light source actuator communicative coupling LSAC to create the three-dimensional map 92C of the air bearing surface 92 of the slider 90, as follows:
First positioning 130 the slider 90 at a slider position 90P through the head gimbal assembly communicative coupling 60C.
Second positioning 132 the first light source LS1 at a first lighting position LSA-P through a light source actuator communicative coupling LSAC.
Generating 320 a flying height estimate 158 for the slider position and the first lighting position.
Adapting 134 the flying height estimate for the slider position and the first lighting position to at least partly create the three-dimensional map 92C of the air bearing surface 92 included in the slider 90.
Altering 136 at least one of the first slider position and/or the first lighting position and repeating the above steps to further create the three-dimensional map of the air bearing surface.

The processor 1000 may preferably control the optical test stand 200 to at least partly implement the first method as follows:
The processor preferably directs the first positioning 130 of the slider 90 at a slider position 90P through the head gimbal assembly communicative coupling 60C. In certain further embodiments, the first positioning of the slider may include activating 140 a micro-actuator assembly 80 coupled to the slider to alter the slider position as shown in FIG. 1K.
The processor preferably directs the second positioning 132 of the first light source LS1 at a first lighting position LSA-P through the light source actuator LSA, in particular, through a light source actuator communicative coupling LSAC.
The processor may preferably use a version of the generating 320 step to create the flying height estimate 158 for the slider position and the first lighting position.
The processor may preferably adapt 134 the flying height estimate for the slider position and the first lighting position to at least partly create the three-dimensional map 92C of the air bearing surface 92.
The processor may alter 136 at least one of the first slider position and/or the first lighting position and repeat the above steps to further create the three-dimensional map of the air bearing surface.

The processor 1000 may further include the following:
Means for first positioning 130 the slider at a slider position through the head gimbal assembly.
Means for second positioning 132 the first light source at a first lighting position through the light source actuator.
Means for generating 320 a flying height estimate 158 for the slider position and the first lighting position.
Means for adapting 134 the flying height estimate for the slider position and the first lighting position to at least partly create the three-dimensional map of the air bearing surface.
Means for altering 136 at least one of the first slider position and/or the first lighting position and repeating the above steps to further create the three-dimensional map of the air bearing surface.

The first method 330 and its implementation as the program system 310 may further include at least one of the following:
Third deriving 138 a camber estimate 160 for the air bearing surface 92.
Fourth deriving 139 a crown estimate 162 for the air bearing surface 92.
And vertical controlling 142 a vertical micro-actuator 98 included in the slider 90 to create an estimate of a vertical actuated deformation 97A of the slider while the vertical micro-actuator 98 is stimulated.

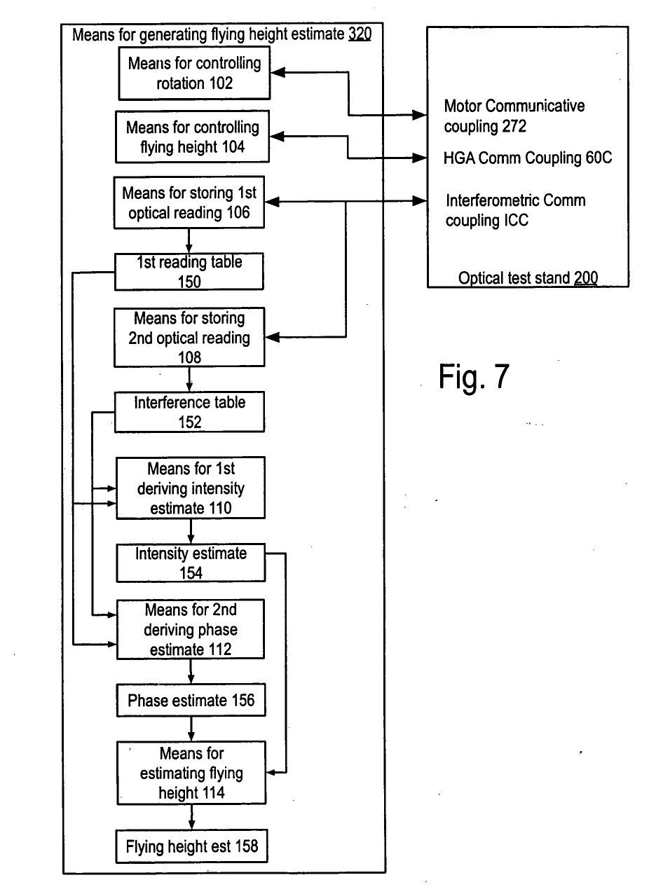

Embodiments may implement generating the flying height estimate by using the optical test stand 200 to estimate flying height FH of the slider 90 from the rotating disk surface 120-R, as shown through the example in FIGS. 6A to 7, performing the following operations:
Controlling rotation 102 of a test disk 12T to create the rotating disk surface 120-R at a rotational frequency RF.
Controlling flying height 104 of a slider 90 above the rotating disk surface, where the slider is coupled to and controlled through a head gimbal assembly 60, preferably using a head gimbal assembly communicative coupling 60C.
Powering a first light source LS1 to provide a first light beam LB of at least one wavelength to the test disk 12T to create a first optical response B1 and to the slider 90 to create a second optical response B2.
Measuring the first optical response B1 to create a first optical reading R1 at a first reading time T1.
Optically combining OC the first optical response and the second optical response B2 to create an interference response B3.
Measuring the interference response to create a second optical reading R2 at a second reading time T2.
First storing 106 the first optical reading in a first reading table 150 based upon the first reading time.
Second storing 108 the second optical reading in an interference table 152 based upon the second reading time.
First deriving 110 an intensity estimate 154 based upon the first reading table, the interference table and the rotational frequency.
Second deriving 112 a phase estimate 156 based upon the first reading table, the interference table, and the rotational frequency.
And estimating 114 based upon the intensity estimate and the phase estimate to create an estimate of the flying height FH as the flying height estimate 158. The flying height estimate is a product of this process.

The processor 1000 may preferably control the optical test stand 200 to at least partly implement generating the flying height estimate as follows:
The processor controls the rotation 102 of the test disk 12T to create the rotating disk surface 120-R at the rotational frequency RF through the motor communicative coupling 272.
The processor controls the flying height 104 the slider 90 above the rotating disk surface head gimbal assembly communicative coupling 60C provided to the head gimbal assembly 60. The control being provided is altered by the aerodynamic forces generated by the interaction of air flow between the rotating disk surface 120-R and the air bearing surface 92 as well as the mechanical response of the actuator assembly 50 and the head gimbal assembly 60, all of which ultimately affect the flying height FH of the slider, particularly at its trailing edge TE, which is often the part of the slider which will be closest to the disk in a hard disk drive 10.
The processor receives a measurement of the first optical response B1 to create the first optical reading R1 at the first reading time T1.
The processor measures the interference response B3 to create the second optical reading R2 at the second reading time T2.
The processor stores the first optical reading in the first reading table 150 based upon the first reading time.
The processor stores the second optical reading in the interference table 152 based upon the second reading time.
The processor derives the intensity estimate 154 based upon the first reading table, the interference table and the rotational frequency RF of the test disk 12T with its test disk surface 120-2 and its rotating disk surface 120-R.
The processor derives the phase estimate 156 based upon the first reading table, the interference table, and the rotational frequency.
And the processor creates the estimate of the flying height, referred to herein a flying height estimate 158 based upon the intensity estimate and the phase estimate. The processor typically reports the flying height estimate as part of a manufacturing process evaluating the head gimbal assembly 60 and/or the slider 90.

The intensity estimate 156 may preferably approximate the ratio of the intensity the second optical reading R2 to the first optical reading R1. The first optical reading is measured from the first optical response B1 of the first light beam and the glass disk 12. The second optical reading is measured from the interference response B3, which results from optically combining OC the first optical response B1 and the second optical response B2. The second optical response results from the first light beam interacting with the slider 90 at its flying height FH above the rotating disk surface 120.

Measuring the first optical response B1 and measuring the interference response B3 may occur concurrently in some embodiments, whereas in others, they may be measured sequentially.

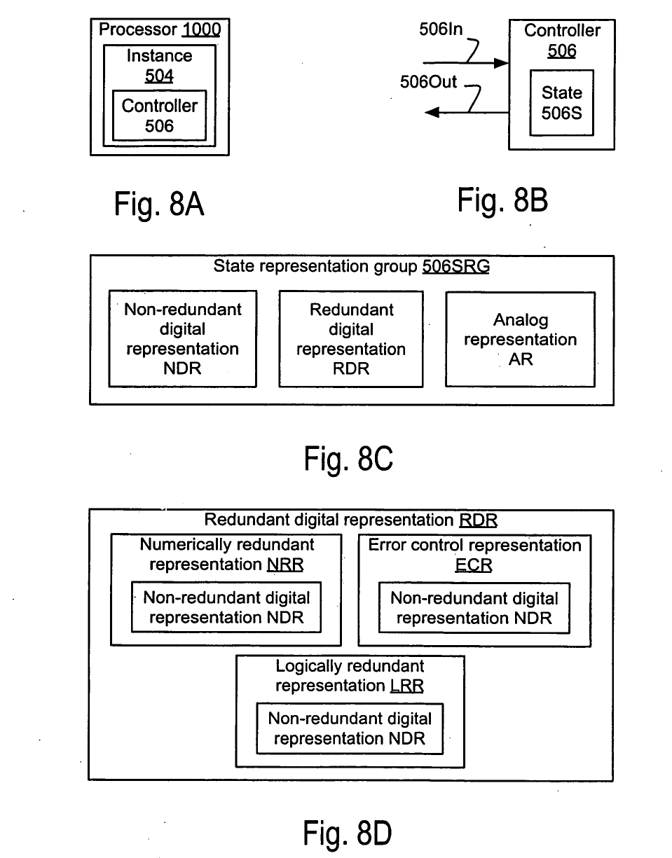

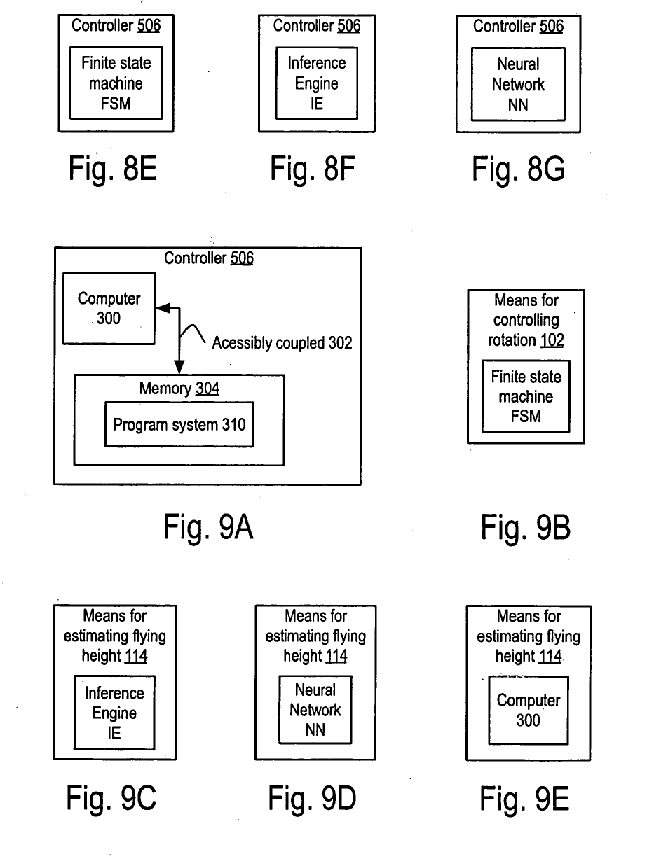

As used herein the processor 1000 may preferably include at least one instance 504 of a controller 506, as shown in FIG. 8A. As used herein, each controller receives at least one input 506In, maintains and updates the value at least one state 506S and generates at least one output 506Out based upon at least one of the inputs and/or the value of at least one of the states, as shown in FIG. 8B.

At least one state 506S may have a value including at least one member of the state representation group 506SRG consisting of the members: a non-redundant digital representation NDR and/or a redundant digital representation RDR and/or an analog representation AR, as shown in FIG. 8C. A non-redundant digital representation frequently comprises at least one digit, which may frequently represent a bit with values of 0 and 1, a byte including eight bits, and so on. Often non-redundant digital representations include representations of 16 bit integers, 32 bit integers, 16 bit floating point numbers, 32 bit floating point numbers, 64 bit floating point numbers, strings of bytes, fixed length buffers of bytes, integers, First-In-First-Out (FIFO) queues of such representations, and so on. Any, all and more than just these examples may be used as non-redundant digital representations of the state of a controller.

A redundant digital representation RDR of a non-redundant digital representation NDR may include a numerically redundant digital representation NRR, an error control representation ECR and/or a logically redundant representation LRR, as shown in FIG. 8D. The following examples will serve to illustrate these redundant representations:

An example of a numerically redundant representation NRR may be found in a standard multiplier, which will often use a local carry propagate adder to add three or four numbers together to generate two numeric components which redundantly represent the numeric result of the addition.

An example of an error control representation ECR will frequently use the non-redundant digital representation and an additional component formed as the function of the non-redundant digital representation. If this error control representation is altered by a few number of bits, a error correcting function reconstructs the original non-redundant digital representation. Quantum computers are considered as controllers which will tend to use this kind of error control representations for at least some states.

An example of a logically redundant representation LRR may be found in the definition and implementation of many finite state machines, which often require that a single state be represented by any member of a multi-element set of non-redundant digital representation. Often the members of this set differ from at least one other member of the set by just one bit. Such logically redundant representations are often used to insure that the generation of glitches is minimized.

As used herein, the controller 506 may include an instance of a finite state machine FSM as shown in FIG. 8E, and/or include an instance of an inference engine IE as shown in FIG. 8F and/or an instance of a neural network NN as shown in FIG. 8G and/or an instance of a computer 300 directed by a program system 310 including program steps or operations residing in a memory 304 accessibly coupled 302 via a buss to the computer as shown in FIG. 9A. As used herein, a computer includes at least one instruction processor and at least one data processor, where each of the data processors is directed by at least one of the instruction processors.

The processor 1000 preferably acts as a control system 100 for the optical test stand 200 as shown in FIG. 7, and may include the following:
Means for controlling rotation 102 of the test disk 12T via the motor communicative coupling 272 to create the rotating disk surface 120-R at the rotational frequency RF.
Means for controlling flying height 104 of the slider 90 coupled to the head gimbal assembly 60 through the head gimbal assembly communicative coupling 60C.
Means for first storing 106 the first optical reading R1 in the first reading table 150 based upon the first reading time T1.
Means for second storing 108 the second optical reading R2 in the interference table 152 based upon the second reading time T2.
Means for first deriving 110 the intensity estimate 154 based upon the first reading table 150, the interference table 152 and the rotational frequency RF.
Means for second deriving 112 the phase estimate 156 based upon the first reading table 150, the interference table 152, and the rotational frequency RF.
And means for estimating 114 based upon the intensity estimate and the phase estimate to create an estimate of the flying height FH, which will also be referred to herein as the flying height estimate 158.

Measuring the first optical response B1 and measuring the interference response B3 may occur concurrently in some embodiments, whereas in others, they may be measured sequentially.

At least one member of the means group may include at least one instance of a computer 300 accessibly coupled 302 to a memory 304 and at least partly directed by a program system 310 including at least one program step residing in the memory, as shown in FIG. 9E, a finite state machine as shown in FIG. 9B, an inference engine as shown in FIG. 9C, and a neural network as shown in FIG. 9D.

As used herein, the means group, consists of: the means for first positioning 130 the slider position 90P as shown in FIG. 6B, the means for second positioning 132 the first light source position LSP, the means for generating 320 the flying height estimate 158, the means for adapting 134 the flying height estimate to the three-dimensional map, the means for altering 136, as well as the means for controlling the rotation 102 as shown in FIG. 7, the means for controlling 104 the flying height FH, the means for storing 106 the first optical reading RI, the means for storing 108 the second optical reading R2, the means for deriving 110 the intensity estimate 154, the means for deriving 112 the phase estimate 156, and the means for estimating flying height 114.

At least one member of the means group may include at least one instance of a computer 300 as shown in FIG. 9E accessibly coupled 302 to a memory 304 and at least partly directed by a program system 310 including at least one program step residing in the memory, a finite state machine FSM as shown in FIG. 9B, an inference engine IE as shown in FIG. 9C, and a neural network NN as shown in FIG. 9D.

One skilled in the art will recognize that the first reading table 150 and the interference table 152 may be implemented as a single table. Alternatively, one or both may be implemented as linked lists. The units for intensity and phase may vary, for instance phase may be represented in degrees of arc. And the flying height may be represented in Angstroms.

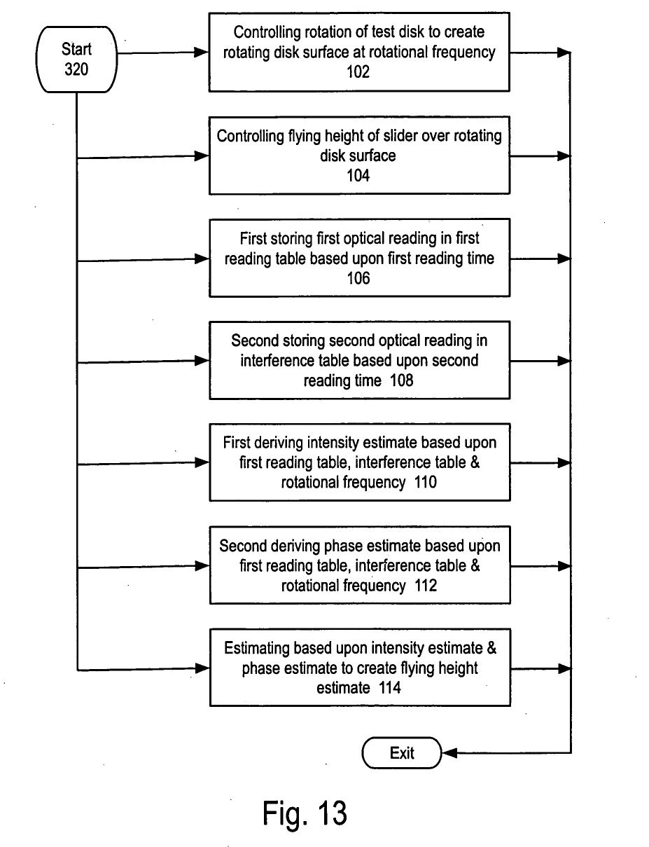

The program system 310 as shown in FIGS. 9A and 10 may at least partly implement the generating step 320 of the flying height estimate by including the following program steps shown in FIG. 13 and residing in the memory 304:
Controlling rotation 102 of the test disk 12T to create the rotating disk surface 120-R at the rotational frequency RF.
Controlling flying height 104 of the slider 90 coupled to the head gimbal assembly 60 via the head gimbal assembly communicative coupling 60C.
First storing 106 the first optical reading R1 in the first reading table 150 based upon the first reading time T1.
Second storing 108 the second optical reading R2 in the interference table 152 based upon the second reading time T2.
First deriving 110 the intensity estimate 154 based upon the first reading table, the interference table and the rotational frequency.
Second deriving 112 the phase estimate 156 based upon the first reading table, the interference table, and the rotational frequency.
And estimating 114 based upon the intensity estimate and the phase estimate to create the flying height estimate 158.

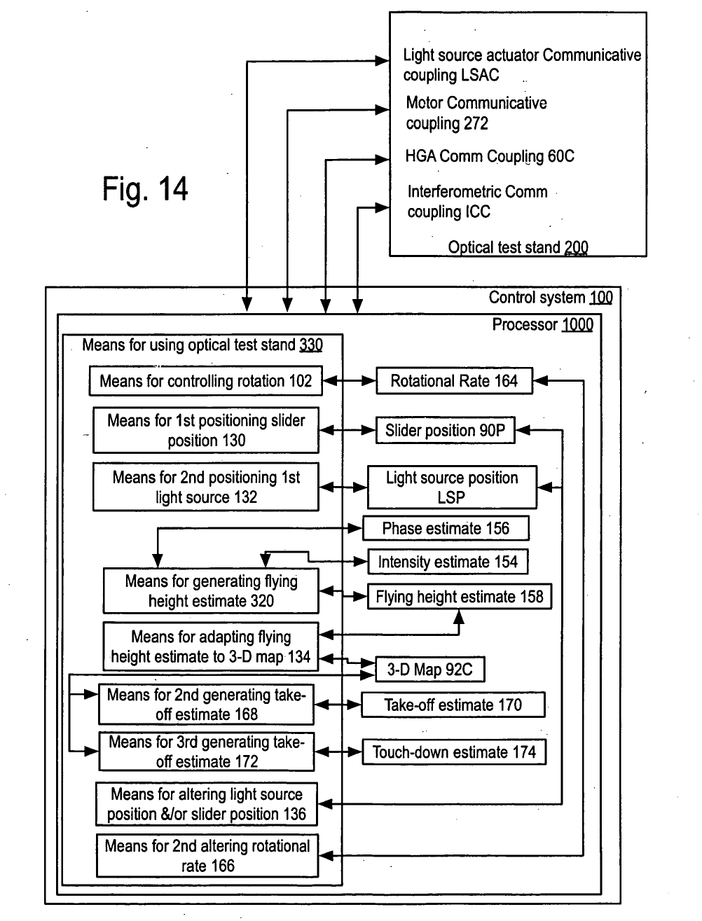

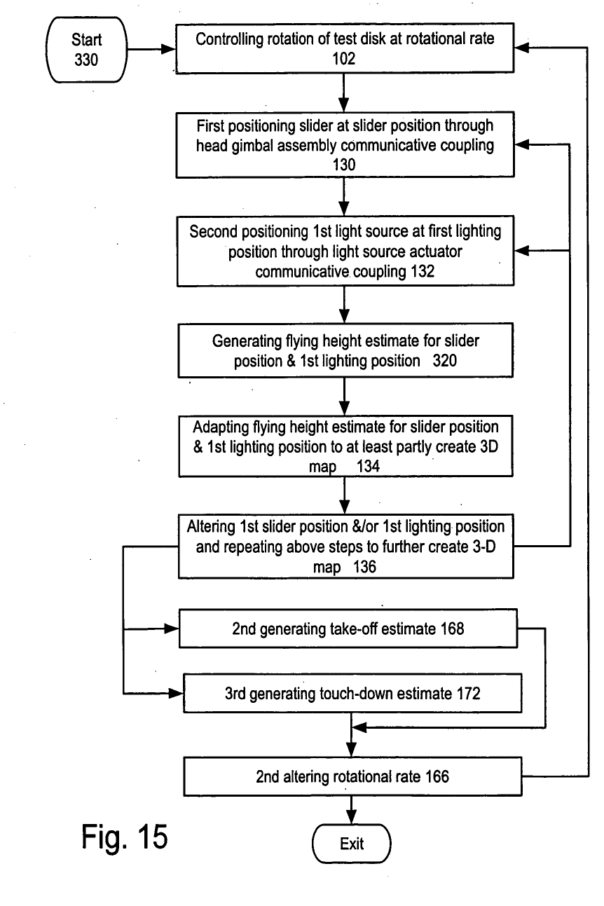

The optical test stand 200 may further be used to make a take-off estimate 170 and/or a touch-down estimate 172, as shown in FIGS. 14 and 15, and discussed as follows:
A rotational rate 164 may be set, and the means for controlling rotation 102 may use the rotational rate when directing the spindle motor 270 through its interaction with the motor communicative coupling 272.
The slider position 90P may be set, and the means for first positioning 130 the slider position may then interact with the head gimbal assembly communicative coupling 60C to keep this positioning stable.
The light source position LSP may be set and the means for second positioning 132 the first light source may then interact via the light source actuator communicative coupling LSAC.
The means for generating 320 the flying height estimate 158 is used by the means for adapting 134 the flying height estimate to the three-dimensional map 92C.
The three dimensional map 92C is used by the means for second generating 168 the take-off estimate 170 and/or the three dimensional map is used by the means for third generating 172 the touch-down estimate 174.
Iteratively, the means for altering 136 the light source position and/or the slider position to incrementally create the three dimensional map.
Iteratively, the means for second altering 166 the rotational rate is used to incrementally create the take-off estimate and/or the touch-down estimate.

The preceding discussion serves to provide examples of the embodiments and is not meant to constrain the scope of the following claims.

What is claimed is:

1. An optical test stand, comprising:
a first optical interferometer using a first light source positioned by a light source actuator to originate a first light path and a second light path;
said first light path includes a reflection off a first disk surface; and
said second light path includes a reflection off an air bearing surface of a slider near a rotating disk surface opposite said first disk surface.

2. The optical test stand of claim 1, wherein said light source actuator positions said first light source with at least one degree of motion-freedom.

3. The optical test stand of claim 1, wherein the motion of said first light source as positioned by said light source actuator is non-parallel to the motion of said air bearing surface of said slider as positioned by an actuator assembly.

4. The optical test stand of claim 3, wherein said motion of said first light source as positioned by said light source actuator in conjunction with said motion of said air bearing surface of said slider as positioned by said actuator assembly supports three dimensional contour mapping of said air bearing surface.

5. The optical test stand of claim 4, wherein said three dimensional contour mapping of said air bearing surface includes an estimate of the crown and of the camber of said air bearing surface.

6. The optical test stand of claim 4, wherein said slider includes a vertical micro-actuator stimulated by a vertical actuation control signal; and
wherein said three dimensional contour mapping of said air bearing surface includes an estimate of a change in flying height of said read-write head of said slider when said vertical actuation control signal stimulates said vertical micro-actuator.

7. The optical test stand of claim 1, further comprising:
a spin table include a first glass substrate coated with a protective layer topped by a layer of lubricant providing said rotating disk surface near which said air bearing surface of said slider is positioned by an actuator assembly;
said first glass substrate is compatible with a second glass substrate used in a disk of a two and one half inch hard disk drive;
said spin table is illuminated by said first optical interferometer measuring said interference between said first light path and said second light path.

8. The optical test stand of claim 1, wherein said first light source emits at least one output band in a blue to ultra-violet color spectrum.

9. The optical test stand of claim 8, wherein said output band is composed of a monochromatic light output component.

10. The optical test stand of claim 8, wherein said output band is composed of a polychromatic light output component.

11. The optical test stand of claim 8, wherein said blue to ultra-violet color spectrum includes all electromagnetic radiation with a wavelength above 449 nanometers and below 501 nanometers.

12. The optical test stand of claim 8, wherein said first light source emits at least two output bands in said blue to ultra-violet color spectrum.

13. The optical test stand of claim 7, wherein said first glass substrate provides said rotating disk surface with a first micro-waviness and said second glass substrate provides a second rotating disk surface with a second micro-waviness; wherein said second rotating disk surface is included in said disk in said hard disk drive;
wherein said first micro-waviness is within N percent of said second micro-waviness;
wherein said N is at most twenty.

14. The optical test stand of claim 13, wherein said N is at most ten.

15. A method of using an optical test stand, comprising the steps:
first positioning a slider at a slider position through control of a head gimbal assembly and an actuator assembly coupled to said head gimbal assembly, whereby said slider is included in said head gimbal assembly;
second positioning a first light source at a first lighting position through control of a light source actuator coupled to said first light source;
generating a flying height estimate for said slider position and said first lighting position by further control of said optical test stand;
adapting said flying height estimate for said slider position and said first lighting position to at least partly create a three dimensional map of an air bearing surface included in said slider; and
altering at least one member of a position group and repeating the above steps to further create said three dimensional map; wherein said members of said position group consist of: said slider position and said first lighting position;
wherein the step generating said flying height estimate, comprises the steps:
controlling the rotation of a test disk to create a rotating disk surface at a rotational frequency;
controlling a flying height of said slider above said rotating disk surface; wherein said slider is coupled to and controlled through a head gimbal assembly;
powering said first light source to provide a light beam of at least one output band to said test disk to create a first optical response and to said slider to create a second optical response;
measuring said first optical response to create a first optical reading at a first reading time;
optically combining said first optical response and said second optical response to create an interference response;
measuring said interference response to create a second optical reading at a second reading time;
storing said first optical reading in a first reading table based upon said first reading time;
storing said second optical reading in an interference table based upon said second reading time;
first deriving an intensity estimate based upon said first reading table, said second reading table and said rotational frequency;
second deriving a phase estimate based upon said first reading table, said second reading table, and said rotational frequency; and
estimating based upon said intensity estimate and said phase estimate to create said flying height estimate.

16. The method of claim 15, further comprising at least one member of the group consisting of the steps:
third deriving a camber estimate of said air bearing surface;
fourth deriving a crown estimate of said air bearing surface; and
vertically controlling a vertical micro-actuator included in said slider to create an estimate of a vertical actuated deformation of said slider while said vertical micro-actuator is stimulated.

17. At least one member of a product group as a product of the process of claim 16;
wherein said product group consists of the members: said three dimensional map, said camber estimate, said crown estimate, said estimate of said vertical actuated deformation, and said flying height estimate.

18. The method of claim 15, wherein said output band is in a blue to ultra-violet color spectrum.

19. The method of claim 18, wherein said light source provides at least two output bands.

20. The method of claim 19, wherein each of said output bands is in said blue to ultra-violet color spectrum.

21. The method of claim 15, wherein said light source is a laser.

22. The method of claim 15, wherein the step measuring said first optical response and the step measuring said interference response occur concurrently.

23. The method of claim 15, wherein the step measuring said first optical response and the step measuring said interference response occur sequentially.

24. The method of generating at least one member of the group consisting of a take-off estimate of said slider and a touch-down estimate of said slider, further comprising the steps of:
second altering a rotational rate provided for controlling rotation of said test disk;
performing the steps of claim 15 to create said three-dimensional map; and
wherein said method further comprises at least one member of the, group consisting of:
second generating said take-off estimate based upon said three-dimensional map; and
third generating said touch-down estimate based upon said three-dimensional map.

25. At least one member of the group consisting of: said take-off estimate, said touch-down estimate, said three-dimensional map, and said flying height estimate as products of the process of claim 24.

26. A control system for said optical test stand of claim 15, comprising:
means for first positioning said slider at said slider position through control of said head gimbal assembly and said actuator assembly coupled to said head gimbal assembly;
means for second positioning said first light source at said first lighting position through control of said light source actuator coupled to said first light source;
means for generating said flying height estimate for said slider position and said first lighting position by further control of said optical test stand;
means for adapting said flying height estimate for said slider position and said first lighting position to at least partly create said three dimensional map of said air bearing surface included in said slider; and
means for altering at least one member of said position group and repeating the above steps to further create said three dimensional map; wherein said members of said position group consist of: said slider position and said first lighting position;
wherein said means for generating, comprises:
means for controlling the rotation of said test disk to create said rotating disk surface at said rotational frequency;
means for controlling said flying height from said slider coupled to said head gimbal assembly;
means for storing said first optical reading in said first reading table based upon said first reading time;
means for storing said second optical reading in said interference table based upon said second reading time;
means for deriving said intensity estimate based upon said first reading table, said second reading table and said rotational frequency;
means for deriving said phase estimate based upon said first reading table, said second reading table, and said rotational frequency; and
means for estimating based upon said intensity estimate and said phase estimate to create said estimate of said flying height.

27. The control mechanism of claim 26, wherein at least one member of a means group includes at least one instance of the group consisting of:
a computer accessibly coupled to a memory and at least partly directed by a program system including at least one program step residing in said memory;
a finite state machine;
an inference engine; and
a neural network;
wherein said computer comprises at least one data processor and at least one instruction processor; wherein each of said data processors is at least partly directed by at least one of said instruction processors;
wherein said means group consists of the members:
said means for controlling said rotation,
said means for controlling said flying height,
said means for storing said first optical reading,
said means for storing said second optical reading,
said means for deriving said intensity estimate,
said means for deriving said phase estimate, and
said means for estimating.

28. The control mechanism of claim 27, wherein said program system, comprises the program steps:
controlling the rotation said test disk to create said rotating disk surface at said rotational frequency;
controlling said flying height from said slider coupled to said head gimbal assembly;
storing said first optical reading in said first reading table based upon said first reading time;
storing said second optical reading in said interference table based upon said second reading time;
deriving said intensity estimate based upon said first reading table, said second reading table and said rotational frequency;
deriving said phase estimate based upon said first reading table, said second reading table, and said rotational frequency; and
estimating based upon said intensity estimate and said phase estimate to create said estimate of said flying height.
